(19) United States
(12) Patent Application Publication
(10) Pub. No.: US 2025/0184177 A1
(43) Pub. Date: Jun. 5, 2025

(54) ON-BOARD COMMUNICATION APPARATUS AND ON-BOARD COMMUNICATION SYSTEM

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventors: Masahiro YASUDA, Yokkaichi-Shi, Mie (JP); Shigeto AKAHORI, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/844,752

(22) PCT Filed: Mar. 1, 2023
(86) PCT No.: PCT/JP2023/007483

§ 371 Date: Sep. 6, 2024

(30) Foreign Application Priority Data
Mar. 9, 2022 (JP) 2022-036516

(51) Int. Cl. H04L 12/46; B60R 16/023

(52) U.S. Cl. CPC H04L 12/46; B60R 16/023

(57) ABSTRACT

Provided is an on-board communication apparatus and an on-board communication system with which it can be expected to improve the extensibility. An on-board communication apparatus according to an embodiment of the present disclosure includes: an application processing unit configured to execute an application program, and a relay processing unit configured to communicate with at least one on-board apparatus, communicate with the application processing unit using a predetermined communication protocol, and relay transmission/reception of data between the on-board apparatus and the application processing unit, the application processing unit includes a plurality of modules that perform processing related to execution of the application program, and the plurality of modules perform communication using the predetermined communication protocol. The predetermined communication protocol may be TCP or UDP.

### CROSS-REFERENCE TO RELATED APPLICATIONS

This application is the U.S. national stage of PCT/JP2023/007483 filed on Mar. 1, 2023, which claims priority of Japanese Patent Application No. JP 2022-036516 filed on Mar. 9, 2022, the contents of which are incorporated herein.

### TECHNICAL FIELD

The present disclosure relates to an on-board communication apparatus and an on-board communication system that are mounted in a vehicle, and perform communication within the vehicle or with another apparatus outside the vehicle.

### BACKGROUND

JP 2008-174098A proposes a vehicle control system that includes a control ECU (Electronic Control Unit) that includes a processor having a real-time OS (Operating System) installed therein and an information ECU that includes a processor having a real-time OS installed therein and a processor having a multimedia OS installed therein. In this vehicle control system, communication between the control ECU and the information ECU is performed by the processors that each have the real-time OS, and communication within the information ECU is performed using an inter-core communication function of the processor that has the real-time OS and an inter-core communication function of the processor that has the multimedia OS.

An on-board communication apparatus according to an aspect of the present disclosure is an on-board communication apparatus to be mounted in a vehicle, and includes: an application processing unit configured to execute an application program, and a relay processing unit configured to communicate with at least one on-board apparatus, communicate with the application processing unit using a predetermined communication protocol, and relay transmission/reception of data between the on-board apparatus and the application processing unit, the application processing unit includes a plurality of modules that perform processing related to execution of the application program, and the plurality of modules perform communication using the predetermined communication protocol.

The present application can be realized not only as an apparatus that includes such characteristic processing units, but can also be realized as a method for executing steps of such characteristic processing, and a computer program for causing a computer to execute such steps. The present application can be realized as a semiconductor integrated circuit that realizes a portion or the entirety of such an apparatus, or can be realized as another apparatus or system that includes such apparatuses.

### SUMMARY

In the vehicle control system according to JP 2008-174098A, communication between the processor of the control ECU and the processors of the information ECU is performed using the CAN (Controller Area Network) communication protocol, for example, and communication between a plurality of cores within the processor is performed using the inter-core communication function that uses a shared memory, for example. In this vehicle control system, for example, when the information ECU needs to communicate with another ECU that performs communication using a communication protocol other than the CAN communication protocol, or the information ECU needs to communicate with the control ECU using a communication protocol other than the CAN communication protocol, there is a need to add, to the information ECU, a function for performing communication using a new communication protocol, and to perform correction and the like of the application program, a software module, and the like that run on the information ECU, and there is a problem in that the flexibility in terms of function extension is low.

The present disclosure has been made in view of such circumstances, and aims to provide an on-board communication apparatus and an on-board communication system with which it can be expected to improve the extensibility.

### Advantageous Effects

According to the above, it can be expected to improve the extensibility of an on-board communication apparatus and an on-board communication system.

### BRIEF DESCRIPTION OF DRAWINGS

FIG. 1 is a schematic diagram showing a configuration of an on-board communication system according to an embodiment of the present disclosure.

FIG. 2 is a block diagram showing a hardware configuration of an on-board communication apparatus according to the embodiment.

FIG. 3 is a block diagram showing a software configuration of the on-board communication apparatus according to the embodiment.

FIG. 4 is a block diagram for describing the extensibility of the on-board communication apparatus according to the embodiment.

FIG. 5 is a block diagram showing a configuration of an on-board communication apparatus according to Modified Example 1.

FIG. 6 is a block diagram showing a configuration of an on-board communication apparatus according to Modified Example 2.

FIG. 7 is a block diagram showing a configuration of an on-board communication system according to Modified Example 3.

### DETAILED DESCRIPTION OF PREFERRED EMBODIMENTS

First, embodiments of the present disclosure will be listed and described. At least some of the embodiments described below may be suitably combined.

An on-board communication apparatus according to an aspect of the present disclosure is an on-board communication apparatus to be mounted in a vehicle, and includes: an application processing unit configured to execute an application program, and a relay processing unit configured to communicate with at least one on-board apparatus, communicate with the application processing unit using a predetermined communication protocol, and relay transmission/reception of data between the on-board apparatus and the application processing unit, the application processing unit includes a plurality of modules that perform processing related to execution of the application program, and the plurality of modules perform communication using the predetermined communication protocol.

According to this aspect, the on-board communication apparatus includes an application processing unit and a relay processing unit. The application processing unit is a processor, a core, an IC (Integrated Circuit), or the like that executes an application program. The relay processing unit is a processor, a core, an IC, or the like that relays transmission/reception of data between the application processing unit and at least one on-board apparatus by communicating with the on-board apparatus, and communicating with the application processing unit using a predetermined communication protocol. The application processing unit includes a plurality of software or hardware modules that perform processing related to execution of the application program. These modules perform communication using the same communication protocol as the communication protocol that is used for communication between the application processing unit and the relay processing unit. Using the same communication protocol for communication within the application processing unit and external communication in this manner makes it easy to, for example, add a function to the application processing unit or change a function of the application processing unit, and it can be expected to improve the extensibility of the on-board communication apparatus.

Preferably, the predetermined communication protocol is TCP (Transmission Control Protocol) or UDP (User Datagram Protocol).

According to this aspect, communication between the application processing unit and the relay processing unit and communication between the plurality of modules within the application processing unit are performed using a communication protocol, namely TCP (Transmission Control Protocol) or UDP (User Datagram Protocol). TCP and UDP are communication protocols that have been conventionally used in a widespread manner, and can be expected to realize reliable communication. In addition, TCP and UDP are communication protocols of the transport layer of the OSI (Open Systems Interconnection) reference model, are higher-level protocols than IP (Internet Protocol) that is a communication protocol of the network layer, and can coexist with each other.

Preferably, the predetermined communication protocol is TCP or UDP, the relay processing unit communicates with the on-board apparatus using LIN (Local Interconnect Network) and CAN (Controller Area Network) communication protocols, transmits data received using the LIN communication protocol to the application processing unit using the UDP communication protocol, and transmits data received using the CAN communication protocol to the application processing unit using the TCP communication protocol.

According to this aspect, the relay processing unit communicates with the at least one on-board apparatus using the LIN (Local Interconnect Network) and CAN (Controller Area Network) communication protocols. The relay processing unit transmits data received using the LIN communication protocol to the application processing unit using the UDP communication protocol, and transmits data received using the CAN communication protocol to the application processing unit using the TCP communication protocol. Accordingly, data that is transmitted/received using the CAN communication protocol that is highly likely to be used to handle data for which relatively high reliability is demanded can be handled using the reliable TCP communication protocol, and data that is transmitted/received using the LIN communication protocol that is highly likely to be used to handle data for which relatively high reliability is not demanded can be handled using the UDP communication protocol that enables high-speed communication with less reliability.

Preferably, the predetermined communication protocol is TCP and UDP, and the application processing unit, the relay processing unit, and the modules transmit/receive data using the TCP or UDP communication protocol based on content of the data.

According to this aspect, communication between the application processing unit and the relay processing unit and communication between a plurality of modules within the application processing unit are performed using the TCP or UDP communication protocol. The application processing unit, the relay processing unit, and the modules switch between the use of the TCP and UDP communication protocols based on the content of data that is transmitted/received. By switching between the use of the TCP and UDP communication protocols as appropriate in accordance with the content of data, for example, it can be expected to suppress the likelihood of important data being lost, and suppress the processing load related to communication processing.

Preferably, the application processing unit, the relay processing unit, and the modules transmit/receive data using the TCP or UDP communication protocol in accordance with ASIL (Automotive Safety Integrity Level) demanded for the data.

According to this aspect, the TCP or UDP communication protocol is used in accordance with ASIL (Automotive Safety Integrity Level) demanded for data that is transmitted/received by the application processing unit, the relay processing unit, and the modules. Accordingly, data for which high ASIL is demanded can be transmitted/received using TCP that is a reliable communication protocol, and data for which low ASIL is demanded can be transmitted/received using UDP that is a communication protocol that enables higher-speed communication with less reliability compared with a case where the data is transmitted/received using TCP.

Preferably, the data that is transmitted/received includes data related to handshake between a plurality of on-board apparatuses or data related to sequence control between a plurality of on-board apparatuses, and the application processing unit, the relay processing unit, and the modules transmit/receive the data related to handshake or the data related to sequence control using the TCP communication protocol.

According to this aspect, by transmitting/receiving data related to handshake or data related to sequence control using the TCP communication protocol, the data can be reliably transmitted/received compared with a case where the data is transmitted/received using the UDP communication protocol. Thus, it can be expected for a plurality of on-board apparatuses to accurately perform a coordinated operation.

Preferably, the data that is transmitted/received includes data related to message authentication or data related to a history of cyberattacks, and the application processing unit, the relay processing unit, and the modules transmit/receive the data related to message authentication or the data related to a history of cyberattacks using the TCP communication protocol.

According to this aspect, by transmitting/receiving data related to message authentication or data related to a history of cyberattacks using the TCP communication protocol, it can be expected to suppress the likelihood of such data being lost, and to reduce a security risk in the security of the vehicle.

Preferably, the data that is transmitted/received includes data related to an indoor condition of the vehicle, and the application processing unit, the relay processing unit, and the modules transmit/receive the data related to the indoor condition using the UDP communication protocol.

According to this aspect, by transmitting/receiving data related to the indoor condition of the vehicle using the UDP communication protocol, the data can be transmitted to an apparatus related to the indoor condition at a faster speed compared with a case where the data is transmitted/received using the TCP communication protocol, and it can be expected that contribution is made to maintenance of a comfortable indoor condition.

Preferably, the data that is transmitted/received includes time-series data related to a travelling state of the vehicle, and the application processing unit, the relay processing unit, and the modules transmit/receive the time-series data related to the travelling state using the UDP communication protocol.

According to this aspect, by transmitting/receiving the time-series data related to the travelling state of the vehicle using the UDP communication protocol, it can be expected to reduce the load of processing related to transmission/reception of the data compared with a case where the data is transmitted/received using the TCP communication protocol. Note that, even when a portion of the time-series data related to the travelling state of the vehicle is eased, for example, the lost data can be estimated based on the data before and after the data is lost, and necessary data can be complemented.

Preferably, the data that is transmitted/received between the application processing unit and the relay processing unit is encrypted.

According to this aspect, the on-board communication apparatus encrypts data that is transmitted/received between the application processing unit and the relay processing unit, and does not encrypt data that is transmitted/received between the plurality of modules within the application processing unit. Accordingly, it can be expected for the on-board communication apparatus to improve the safety by encrypting data that is easily intercepted from outside, and to transmit/receive data that is not easily intercepted from outside, at a high speed without encrypting it.

An on-board communication apparatus according to an aspect of the present disclosure is an on-board communication apparatus to be mounted in a vehicle, and includes an application core that executes an application program, the application core executes a plurality of software modules related to the application program, and the plurality of software modules transmit/receive data using a TCP or UDP communication protocol.

According to this aspect, the on-board communication apparatus includes an application core that executes an application program, and this application core executes a plurality of software modules related to the application program. The plurality of software modules transmit/receive data using a TCP or UDP communication protocol. Accordingly, the on-board communication apparatus can perform communication between the software modules within the core using one of the TCP and UDP communication protocols that are often adopted for inter-core communication, inter-apparatus communication, and the like, and by using the same communication protocol for communication within the core and communication with an apparatus outside the core, it can be expected to improve the extensibility of the on-board communication apparatus.

An on-board communication system according to this aspect is an on-board communication system to be mounted in a vehicle, and includes: an application processing apparatus that executes an application program, and a relay processing apparatus that communicates with at least one on-board apparatus, communicates with the application processing apparatus using a predetermined communication protocol, and relays transmission/reception of data between the application processing apparatus and the on-board apparatus, the application processing apparatus includes a plurality of modules that perform processing related to execution of the application program, and the plurality of modules perform communication using the predetermined communication protocol. Examples of the application processing apparatus include an ECU that can execute an application program. In addition, examples of the relay processing apparatus include a gateway ECU.

According to this aspect, similarly to the aspect (1), it can be expected to improve the extensibility of the on-board communication apparatus.

In addition, an on-board communication apparatus according to an aspect of the present disclosure is an on-board communication apparatus to be mounted in a vehicle, and includes an application processing unit configured to execute an application program, the application processing unit includes a plurality of modules that perform processing related to execution of the application program, and performs external communication using a predetermined communication protocol, and the plurality of modules perform communication using the predetermined communication protocol.

According to this aspect, the on-board communication apparatus includes an application processing unit configured to execute an application program, this application processing unit includes a plurality of modules related to execution of the application program. The application processing unit performs external communication (with another processing unit or another apparatus) using the predetermined communication protocol, the plurality of modules within the application processing unit also perform communication using the predetermined communication protocol. Accordingly, it can be expected to improve the extensibility of the on-board communication apparatus by using the same communication protocol for communication within the application processing unit and external communication.

Specific examples of an on-board communication system according to embodiments of the present disclosure will be described below with reference to the drawings. The present disclosure is not limited to illustrations of these, but is indicated by the claims, and is intended to include all modifications that are within the meanings and the scope that are equivalent to those of the claims.

### System Configuration

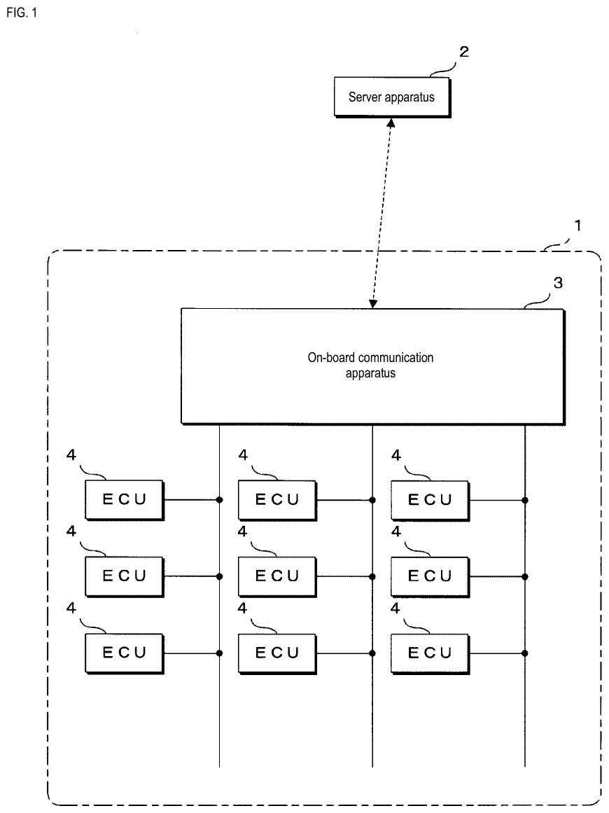

FIG. 1 is a schematic diagram showing a configuration of an on-board communication system according to an embodiment of the present disclosure. The on-board communication system according to the present embodiment is a system in which an on-board communication apparatus 3 mounted in a vehicle 1 collects various types of information from one or more other ECUs 4, and transmits the collected information to a server apparatus 2 provided outside the vehicle 1. In the vehicle 1 according to the present embodiment, for example, the plurality of ECUs 4 that perform various types of processing such as control processing related to travelling of the vehicle 1, information processing for collecting information regarding the surroundings of the vehicle 1, and processing for providing information to the user are mounted at appropriate locations. These ECUs 4 are connected to each other via communication lines routed in the vehicle 1, and operate in cooperation by exchanging data, that is transmitting/receiving data to/from each other via these communication lines.

In addition, these ECUs 4 are connected to the on-board communication apparatus 3 via the communication lines. The on-board communication system shown in FIG. 1 has a network configuration in which three communication lines are connected to the on-board communication apparatus 3, and three ECUs 4 are connected to each of the communication lines. That is to say, three ECUs 4 are connected to one communication line in a bus network configuration, and the three communication lines that each constitute this bus network are connected to the on-board communication apparatus 3 in a start network configuration. Note that the illustrated network configuration is exemplary, there is no limitation thereto, and the on-board communication apparatus 3 and the plurality of ECUs 4 mounted in the vehicle 1 may be connected to each other in various network configurations such as a bus network configuration, a star network configuration, and a ring network configuration.

The on-board communication apparatus 3 relays transmission/reception of data between a plurality of communication lines connected thereto, and relays transmission/reception of data between the server apparatus 2 provided outside the vehicle 1 and an ECU 4 within the communication apparatus 3 relays vehicle 1. The on-board transmission/reception of data between ECUs 4 mounted in the vehicle 1 by transmitting data received from one communication line, using at least one other communication line, for example. In addition, for example, the on-board communication apparatus 3 relays transmission/reception of data between the server apparatus 2 and an ECU 4 by transmitting data received from the server apparatus 2, using at least one communication line. In addition, for example, the on-board communication apparatus 3 relays transmission/reception of data between the server apparatus 2 and an ECU 4 by transmitting data received from the ECU 4 to the server apparatus 2.

### Apparatus Configuration

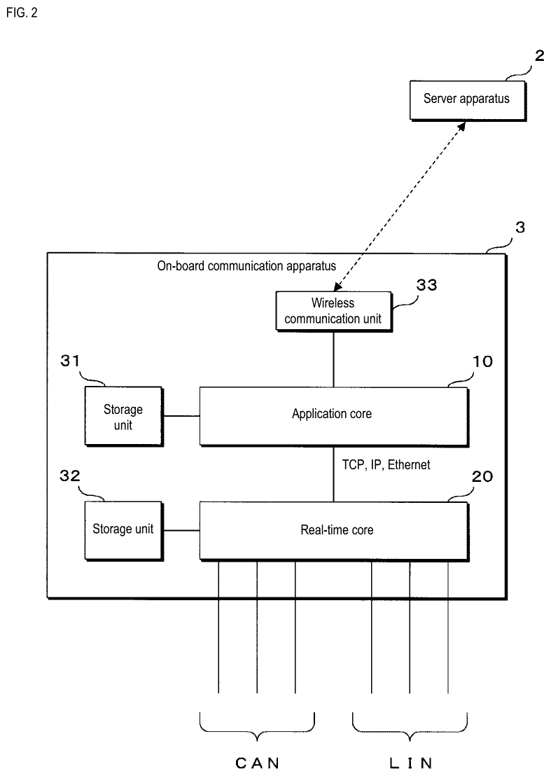

FIG. 2 is a block diagram showing a hardware configuration of the on-board communication apparatus 3 according to the present embodiment. The on-board communication apparatus 3 according to the present embodiment is configured including an application core 10, a real-time core 20, storage units 31 and 32, a wireless communication unit 33, and the like. In the present embodiment, each of the cores of the on-board communication apparatus 3 is an IC obtained by integrating, into a single package, a computation processing unit such as a CPU (Central Processing Unit) or an MPU (Micro-Processing Unit), a storage unit such as an SRAM (Static Random Access Memory) or a DRAM (Dynamic Random Access Memory), and at least one communication unit that performs communication using a communication protocol of CAN, LIN, Ethernet (registered trademark), or the like, for example. Note that, in the present embodiment, the on-board communication apparatus 3 includes two cores, namely the application core 10 and the real-time core 20, which are so-called single-core ICs, and the IC of the application core 10 and the IC of the real-time core 20 are mounted on a circuit board or the like of the on-board communication apparatus 3. Note that the on-board communication apparatus 3 may have a configuration in which a so-called multi-core IC is provided, and this single IC includes the application core 10 and the real-time core 20.

The storage units 31 and 32 are each configured using a non-volatile memory element such as a flash memory or an EEPROM (Electrically Erasable Programmable Read Only Memory). The storage unit 31 stores various computer programs such as an application program that is executed by the application core 10, and an OS, and data required for executing these computer programs. The storage unit 32 stores various computer programs such as a communication program that is executed by the real-time core 20, and a real-time OS, and data required for executing these computer programs. Note that, in the present embodiment, a configuration is adopted in which the on-board communication apparatus 3 includes the storage units 31 and 32 for the respective cores, but there is no limitation thereto, and a configuration may also be adopted in which one storage unit is shared by the application core 10 and the real-time core 20.

The wireless communication unit 33 performs wireless communication with the server apparatus 2 provided outside the vehicle 1, via a mobile phone communication network, a wireless LAN (Local Area Network), or the like. Note that the wireless communication unit 33 may also communicate with various apparatuses provided outside the vehicle 1, aside from the server apparatus 2. The wireless communication unit 33 transmits data provided from the application core 10, to the server apparatus 2, and provides data received from the server apparatus 2, to the application core 10. The wireless communication unit 33 is mounted on the circuit board of the on-board communication apparatus 3 as a single IC, for example, and can provide/receive data to/from the application core 10 via wiring provided on the circuit board. Note that the wireless communication unit 33 may be provided in the application core 10.

The application core 10 of the on-board communication apparatus 3 according to the present embodiment is a core that executes an application program, for example, and the real-time core 20 is a core that perform relay processing related to communication in the vehicle 1. The application core 10 and the real-time core 20 are mounted on the circuit board of the on-board communication apparatus 3, for example, are electrically connected to each other via the wiring provided on the circuit board, and provide/receive data to/from each other via this wiring. In the present embodiment, the application core 10 and the real-time core 20 provide/receive data by performing communication via this wiring using TCP (or UDP), IP, and Ethernet communication protocols.

The real-time core 20 communicates with at least one ECU 4 provided in the vehicle 1, via at least one communication line connected to the on-board communication apparatus 3. In the illustrated example, three communication lines that comply with the CAN communication protocol and three communication lines that comply with the LIN communication protocol are connected to the on-board communication apparatus 3. These communication lines are connected to one or more connectors provided on the circuit board of the on-board communication apparatus 3, and the real-time core 20 and these connectors are electrically connected to each other via wiring provided on the circuit board, for example. The real-time core 20 relays transmission/reception of data between ECUs 4 connected to these communication lines, and relays transmission/reception of data between the application core 10 and ECUs 4.

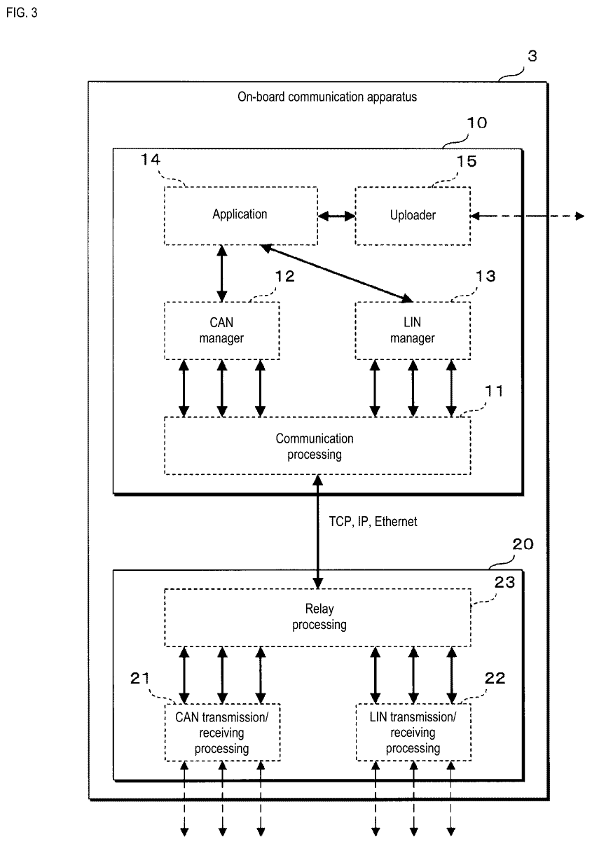

FIG. 3 is a block diagram showing a software configuration of the on-board communication apparatus 3 according to the present embodiment. The on-board communication apparatus 3 according to the present embodiment is realized by software modules indicated by blocks of broken lines in FIG. 3, as a result of the application core 10 and the real-time core 20 executing programs stored in the storage units 31 and 32. Note that, in the present embodiment, the modules indicated by the blocks of the broken lines in FIG. 3 are software modules realized by executing programs, but there is no limitation thereto, and the modules may be hardware modules realized as hardware.

In the present embodiment, the application core 10 includes a communication processing module 11, a CAN manager module 12, a LIN manager module 13, an application module 14, an uploader module 15, and the like. Also, the real-time core 20 includes a CAN transmission/receiving processing module 21, a LIN transmission/receiving processing module 22, a relay processing module 23, and the like. Note that FIG. 3 shows the names of the blocks in which “module” is omitted.

In the on-board communication apparatus 3 according to the present embodiment, data is provided/received between a plurality of modules within each core by the modules performing communication in compliance with the TCP or UDP communication protocol. In addition, in the on-board communication apparatus 3 according to the present embodiment, data is provided/received between the application core 10 and the real-time core 20 by the cores performing communication in compliance with the TCP or UDP communication protocol. In this manner, in the on-board communication apparatus 3 according to the present embodiment, providing/reception of data within each core and providing/reception of data between the cores are performed through communication that uses a common communication protocol. In FIG. 3, communication that uses the TCP or UDP communication protocol is indicated by an arrow of solid line, and communication that uses a communication protocol other than TCP and UDP (for example, CAN or LIN) is indicated by an arrow of one dotted chain line.

Note that, in the OSI reference model for communication protocols, TCP or UDP is a communication protocol classified as a protocol of the transport layer. In the present embodiment, in inter-core communication between the application core 10 and the real-time core 20, the TCP or UDP communication protocol is used for the transport layer, the IP communication protocol is used for the network layer, for example, and the Ethernet communication protocol is used for the data link layer.

In contrast, communication between modules within each of the application core 10 and the real-time core 20 is communication obtained by virtually realizing at least the TCP or UDP communication protocol of the transport layer using software (for example, an OS), and communication protocols of the network layer and the data link layer do not need to be virtually reproduced (may be reproduced). In the on-board communication apparatus 3 according to the present embodiment, for communication between modules, the IP communication protocol of the network layer is virtually reproduced, and no communication protocol of the data link layer is reproduced. At least one port number is allocated to each of the modules within the cores, and the module can designate a port number of a module that is a transmission destination, and transmit data. Software such as an OS that is running on each core specifies a module corresponding to a port number added to data transmitted by another module, and provides this data to the specified module, and as a result, the data is provided/received between the modules.

In addition, in the on-board communication apparatus 3 according to the present embodiment, IP addresses are respectively set in the application core 10 and the real-time core 20 in advance. A module in each of the application core 10 and the real-time core 20 can provide/receive data to/from a module in the other core by designating the IP address and the port number. Software such as an OS that is running in each core can determine whether a transmission destination of data transmitted by each module is a module in the core or a module of the other core, based on the IP address added to this data.

The CAN transmission/receiving processing module 21 of the real-time core 20 is a module for performing communication with the ECUs 4 in the vehicle 1 using the CAN communication protocol. The CAN transmission/receiving processing module 21 receives data (a message, a frame, etc.) that complies with the CAN communication protocol from an ECU 4 via the communication line, converts the received data into data that complies with the TCP or UDP communication protocol, and transmits the resultant data to the relay processing module 23. In addition, the CAN transmission/receiving processing module 21 receives data that complies with the TCP or UDP communication protocol, from the relay processing module 23, converts the received data into data that complies with the CAN communication protocol, and transmits the resultant data to an ECU 4. Note that, in the present embodiment, in a case where three communication lines that comply with the CAN communication protocol are connected to the on-board communication apparatus 3, at least three port numbers are allocated to the CAN transmission/receiving processing module 21, and the three port numbers and the three communication line are associated with each other. Accordingly, another module can transmit data to a communication line corresponding to one of these port numbers, by designating the port number and transmitting data to the CAN transmission/receiving processing module 21.

The LIN transmission/receiving processing module 22 is a module for performing communication with the ECUs 4 in the vehicle 1 using the LIN communication protocol. The LIN transmission/receiving processing module 22 receives data that complies with the LIN communication protocol, from an ECU 4 via the communication line, converts the received data into data that complies with the TCP or UDP communication protocol, and transmits the resultant data to the relay processing module 23. In addition, the LIN transmission/receiving processing module 22 receives data that complies with the TCP or UDP communication protocol from the relay processing module 23, converts the received data into data that complies with the LIN communication protocol, and transmits the resultant data to an ECU 4. Note that, in the present embodiment, in a case where three communication lines that comply with the LIN communication protocol are connected to the on-board communication apparatus 3 similarly to the case of the CAN transmission/receiving processing module 21, at least three port numbers are allocated to the LIN transmission/receiving processing module 22, and the three port numbers and the three communication lines are associated with each other.

The relay processing module 23 performs processing for relaying transmission/reception of data between the CAN transmission/receiving processing module 21, the LIN transmission/receiving processing module 22, and the application core 10. The relay processing module 23 relays data between CAN and LIN in the vehicle 1 by transmitting data received from the CAN transmission/receiving processing module 21 to the LIN transmission/receiving processing module 22, and transmitting data received from the LIN transmission/receiving processing module 22 to the CAN transmission/receiving processing module 21, for example. In addition, for example, the relay processing module 23 relays data between the application core 10 and an ECU 4 in the vehicle 1, by transmitting data received from the CAN transmission/receiving processing module 21 or the LIN transmission/receiving processing module 22, to the application core 10 (or a specific module in the application core 10), and transmitting data received from the application core 10 to the CAN transmission/receiving processing module 21 or the LIN transmission/receiving processing module 22.

The communication processing module 11 of the application core 10 transmits/receives data to/from the real-time core 20, transmits data received from the real-time core 20 to a module in the application core 10, and transmits data received from a module in the application core 10 to the real-time core 20. The communication processing module 11 relays data between (the relay processing module 23 of) the real-time core 20 and the CAN manager module 12 and the LIN manager module 13 in the application core 10, for example.

The CAN manager module 12 is a module for virtually providing, to the application module 14, a communication function that uses the CAN communication protocol and is performed by the on-board communication apparatus 3. Accordingly, the application module 14 can transmit/receive data to/from the ECUs 4 mounted in the vehicle 1, by transmitting/receiving data to/from the CAN manager module 12. A plurality of port numbers corresponding to the plurality of port numbers allocated to the CAN transmission/receiving processing module 21 are allocated to the CAN manager module 12, and the application module 14 can transmit data to an ECU 4 through a corresponding CAN communication line by designating a port number and transmitting the data to the CAN manager module 12.

The LIN manager module 13 is a module for virtually providing, to the application module 14, a communication function that uses the LIN communication protocol and is performed by the on-board communication apparatus 3. Accordingly, the application module 14 can transmit/receive data to/from the ECUs 4 mounted in the vehicle 1 by transmitting/receiving the data to/from the LIN manager module 13. A plurality of port numbers corresponding to the plurality of port numbers allocated to the LIN transmission/receiving processing module 22 are allocated to the LIN manager module 13, and the application module 14 can transmit data to an ECU 4 through a corresponding LIN communication line by designating a port number and transmitting the data to the LIN manager module 13.

The application module 14 is a module that performs various types of processing such as providing information to the driver of the vehicle 1 or transmitting information to the outside of the vehicle 1, based on data collected from the ECUs 4 mounted in the vehicle 1. FIG. 3 shows only one application module 14, but a plurality of application modules 14 can be executed in parallel as the application module 14. The application module 14 according to the present embodiment performs processing for transmitting data in the vehicle 1 to the external server apparatus 2, and transmitting data received from the server apparatus 2 to the ECUs 4 of the vehicle 1. The application module 14 receives data from the CAN manager module 12 or the LIN manager module 13, performs appropriate processing on the received data, and transmits the processed data to the uploader module 15, and can thus transmit the data to the server apparatus 2. In addition, the application module 14 receives data from the uploader module 15, designates an appropriate port number, transmits the received data to the CAN manager module 12 or the LIN manager module 13, and can thus transmit the data to an ECU 4 connected to a CAN or LIN communication line corresponding to the port number.

The uploader module 15 is a module that communicates with the server apparatus 2 by controlling operations of the wireless communication unit 33. In the present embodiment, the uploader module 15 receives data from the application module 14, and transmits (uploads) the received data to the server apparatus 2. In addition, when data of some sort has been received from the server apparatus 2 as a response to transmission of data, the uploader module 15 may transmit the received data to the application module 14.

### Function Extension of Core

In the on-board communication apparatus 3 according to the present embodiment, communication between the application core 10 and the real-time core 20 is performed using the TCP or UDP communication protocol, and communication between a plurality of modules in the application core 10 is performed using the TCP or UDP communication protocol. Accordingly, each module in the application core 10 can transmit/receive data using the same communication method irrespective of whether or not the communication partner is in the same core.

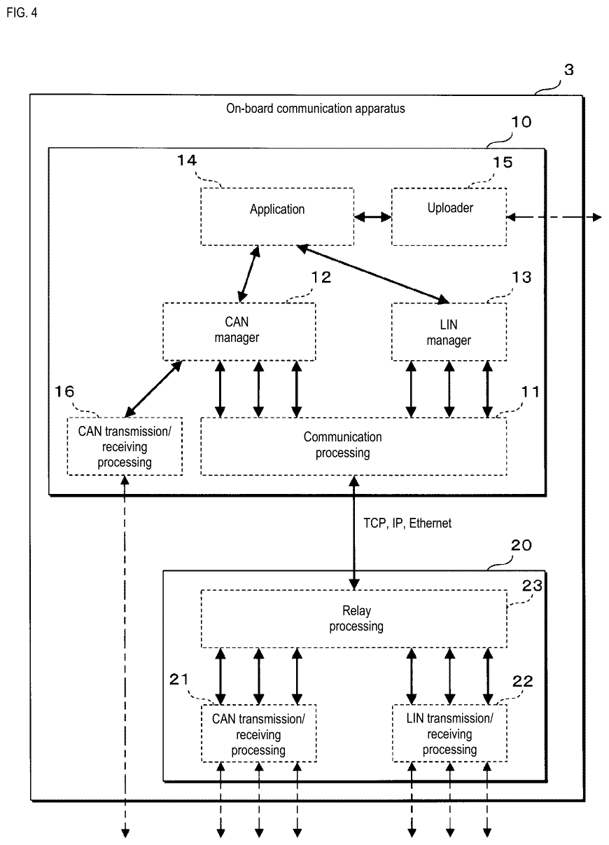

FIG. 4 is a block diagram for describing extensibility of the on-board communication apparatus 3 according to the present embodiment. The on-board communication apparatus 3 illustrated in FIG. 4 has a configuration in which a CAN communication line is directly connected to the application core 10, and a function for directly performing CAN communication without using the real-time core 20 is added to the application core 10, in contrast with the configuration of the on-board communication apparatus 3 shown in FIG. 3.

In order to add this function, a CAN transmission/receiving processing module 16 that is similar to that of the real-time core 20 is provided to the application core 10. The CAN transmission/receiving processing module 16 performs communication with the ECUs 4 in the vehicle 1 using the CAN communication protocol, and performs communication with each module in the application core 10 such as the CAN manager module 12 using the TCP or UDP communication protocol, for example. An appropriate port number is allocated to the CAN transmission/receiving processing module 16, and, for example, the CAN manager module 12 can transmit data to an ECU 4 in the vehicle 1 by designating the port number and transmitting the data irrespective of whether the CAN communication line is connected to the application core 10 or the real-time core 20.

### Use Switching Between TCP and UDP

In the on-board communication apparatus 3 according to the present embodiment, inter-core communication between the application core 10 and the real-time core 20 and communication between modules in each core are performed using the TCP or UDP communication protocol. Both TCP and UDP that are communication protocols of the transport layer are higher-level protocols than IP that is a communication protocol of the network layer, and can coexist with each other. The on-board communication apparatus 3 according to the present embodiment can use both the TCP and UDP communication protocols, and when transmitting data, each module may select the TCP or UDP communication protocol in accordance with the content, type, the degree of importance or the like of the data, and transmit the data using the selected communication protocol.

A configuration may be adopted in which, for example, data that is transmitted/received by an ECU 4 outside the on-board communication apparatus 3 using the CAN communication protocol is transmitted/received inside the on-board communication apparatus 3 using the TCP communication protocol, and data that is transmitted/received by an ECU 4 outside the on-board communication apparatus 3 using the LIN communication protocol is transmitted/received inside the on-board communication apparatus 3 using the UDP communication protocol. In this case, upon receiving data from an ECU 4 of the vehicle 1, the CAN transmission/receiving processing module 21 transmits this data to the relay processing module 23 using the TCP communication protocol, and a module that receives this data from this point on transmits/receives the data using the TCP communication protocol. Upon receiving data from an ECU 4 of the vehicle 1, the LIN transmission/receiving processing module 22 transmits this data to the relay processing module 23 using the UDP communication protocol, and a module that receives this data from this point on transmits/receives the data using the UDP communication protocol. When data generated by a module such as the application module 14 is transmitted to an ECU 4 connected to a CAN communication line, the module transmits this data using the TCP communication protocol, and, when the data is transmitted to an ECU 4 connected to a LIN communication line, the module transmits this data using the UDP communication protocol.

In addition, for example, the on-board communication apparatus 3 may select the TCP or UDP communication protocol in accordance with ASIL demanded for data that is transmitted/received. ASIL refers to a safety level stipulated in ISO26262 that is a functional safety standard for the automobile industry, and five safety levels, namely D, C, B, A, and QM are defined in descending order of safety. It is conceivable that, for example, a level related to the systems of a brake, steering, and the like is set as the level D, a level related to the systems of cruise control and the like is set as the level C, a level related to the systems of headlights, brake lamps, and the like is set as the level B, a level related to the systems of backlights and the like is set as the level A, and a level that is not related to the safety of the vehicle is set as QM. Each module of the on-board communication apparatus 3 can use the TCP communication protocol when transmitting/receiving data related to the systems set to the level D and the level C of the ASIL, and use the UDP communication protocol when transmitting/receiving data related to the systems set to the level B, the level A, and QM.

In addition, for example, when data related to handshake or data related to sequence control is transmitted/received between a plurality of ECUs 4, the on-board communication apparatus 3 transmits/receives such data using the TCP communication protocol. The data related to handshake is data that is exchanged between a plurality of ECUs 4 before communication is started, for example, and can include information such as settings related to communication. The sequence control is a control method for advancing stages of control in predetermined order. The data related to sequence control can include data for performing notification, instruction, and the like of start or end of a control stage, for example.

In addition, for example, when transmitting/receiving data related to message authentication or data related to a history of cyberattacks, the on-board communication apparatus 3 transmits/receives such data using the TCP Examples of the data related to message communication protocol. authentication include data to which MAC (Message Authentication Code) is given and data that includes key information that is used for encryption. In addition, when a cyberattack such as a DoS (Denial of Service) attack is detected, an ECU 4 may notify another ECU 4 or the like that the ECU 4 has been cyberattacked, for example. The data related to a history of cyberattacks may include notification data that is transmitted from an ECU 4 that is under such a cyberattack.

In addition, for example, when transmitting/receiving data related to the indoor condition of the vehicle 1, the on-board communication apparatus 3 transmits/receives such data using the UDP communication protocol. Examples of the data related to the indoor condition can include data related to settings, operations, or the like of an in-vehicle device such as an air-conditioning device or a lighting device.

In addition, for example, when transmitting/receiving time-series data related to the travelling state of the vehicle 1, the on-board communication apparatus 3 transmits/receives such data using the UDP communication protocol. Examples of the time-series data related to the travelling state can include data obtained by a sensor periodically detecting the speed, the acceleration rate, the steering angle, or the like of the vehicle 1.

Note that, in inter-core communication and inter-module communication of the on-board communication apparatus 3, a criterion for switching between the use of the TCP and UDP communication protocol is not limited to a criterion that is based on a communication protocol that is used for a network in the vehicle 1 such as CAN and LIN described above and a criterion that is based on ASIL level demanded for data, and any criterion may be adopted.

### Encryption

In the on-board communication apparatus 3 according to the present embodiment, communication between cores, namely the application core 10 and the real-time core 20 and communication between modules in each core may be performed using the TCP or UDP communication protocol, and data may be encrypted and transmitted/received in inter-core communication, and data may be transmitted/received without being encrypted for communication within each core. The relay processing module 23 of the real-time core 20 encrypts data to be transmitted to the application core 10, and transmits the encrypted data to the communication processing module 11 of the application core 10, for example. The communication processing module 11 that has received the encrypted data decrypts the encrypted data, and transmits the decrypted data to the CAN manager module 12, the LIN manager module 13, or the like. Similarly, the communication processing module 11 of the application core 10 encrypts data to be transmitted to the real-time core 20, and transmits the encrypted data to the relay processing module 23 of the real-time core 20. The relay processing module 23 that has received the encrypted data decrypts the encrypted data, and transmits decrypted data to the CAN transmission/receiving processing module 21, the LIN transmission/receiving processing module 22, or the like. The relay processing module 23 and the communication processing module 11 encrypt and decrypt data that is to be transmitted/received, using a common key, for example. Note that the on-board communication apparatus 3 can encrypt data using SSL (Secure Sockets Layer) or TLS (Transport Layer Security).

Note that determination can be performed as to whether or not to encrypt data to be transmitted/received, based on whether or not the data to be transmitted/received is output as a signal to the outside of the IC, for example. As described above, a configuration in which data that is transmitted/received between cores is encrypted, and data that is transmitted/received within a core is not encrypted as described above envisions that the application core 10 and the real-time core 20 are mounted on the circuit board of the on-board communication apparatus 3 as separate ICs. In a case of a configuration in which the application core 10 and the real-time core 20 are accommodated in a single IC, that is to say a so-called multicore, there is no need to encrypt data that is transmitted/received between cores.

Note that a criterion for determining whether or not to encrypt data that is transmitted/received in the on-board communication apparatus 3 is not limited to a criterion that is based on whether or not the data is to be output to the outside of the IC, and any criterion may be adopted. In addition, the on-board communication apparatus 3 may encrypt both data to be transmitted/received between cores and data to be transmitted/received within a core, and conversely, both data to be transmitted/received between cores and data to be transmitted/received within a core do not need to be encrypted.

### Modified Example 1

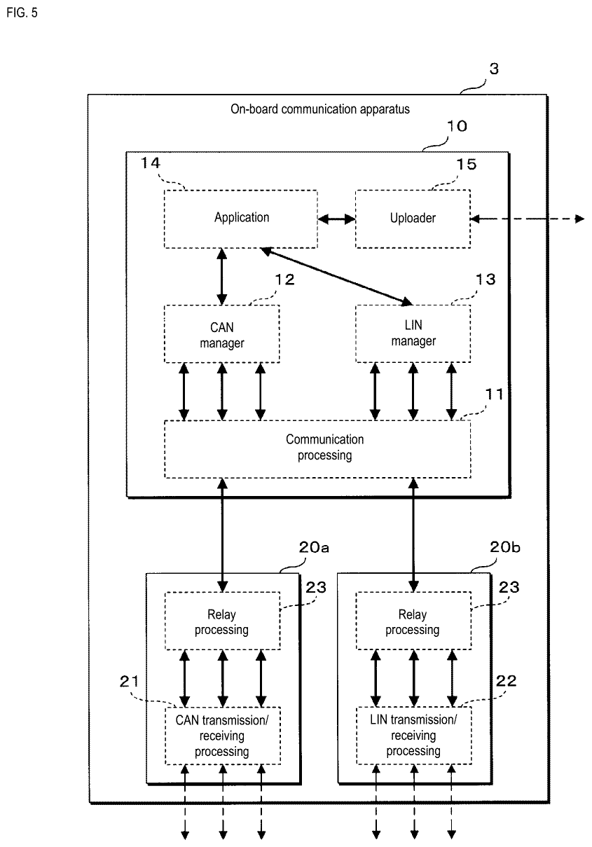

FIG. 5 is a block diagram showing a configuration of an on-board communication apparatus 3 according to Modified Example 1. The on-board communication apparatus 3 according to Modified Example 1 includes one application core 10 and two real-time cores 20a and 20b. The application core of the on-board communication apparatus 3 according to Modified Example 1 has the same configuration as the application core 10 shown in FIG. 3.

The two real-time cores 20a and 20b of the on-board communication apparatus 3 according to Modified Example 1 are equivalent to what is obtained as a result of dividing the function of the real-time core 20 shown in FIG. 3 into two. That is to say, the first real-time core 20a includes the CAN transmission/receiving processing module 21 and the relay processing module 23, and performs transmission/reception of data between ECUs 4 of the vehicle 1 using the CAN communication protocol, and performs transmission/reception of data with the application core 10 using the TCP or UDP communication protocol. In addition, the second real-time core 20b includes the LIN transmission/receiving processing module 22 and the relay processing module 23, transmits/receives data to/from the ECUs 4 of the vehicle 1 using the LIN communication protocol, and transmits/receives data to/from the application core 10 using the TCP or UDP communication protocol.

Note that the three cores of the on-board communication apparatus 3 according to Modified Example 1 may be mounted as individual ICs, or two or three cores may be mounted as a single IC, for example. In addition, the on-board communication apparatus 3 according to Modified Example 1 includes the first real-time core 20a that has a CAN communication function and the second real-time core 20b that has a LIN communication function, but there is no limitation thereto, and, for example, two cores that are same as the real-time core 20 shown in FIG. 3 may be included. That is to say, the on-board communication apparatus 3 may include two real-time cores 20 that each have the CAN communication function and the LIN communication function. In addition, the on-board communication apparatus 3 may include three or more real-time cores.

### Modified Example 2

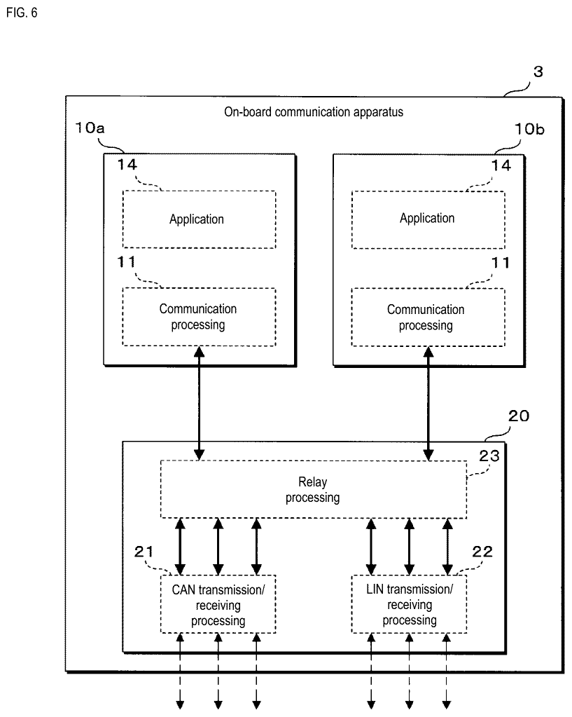

FIG. 6 is a block diagram showing a configuration of an on-board communication apparatus 3 according to Modified Example 2. The on-board communication apparatus 3 according to Modified Example 2 includes two application cores 10a and 10b and one real-time core 20. The real-time core 20 of the on-board communication apparatus 3 according to Modified Example 2 is the same as the real-time core 20 shown in FIG. 3. In addition, FIG. 6 shows a schematic configuration of the modules of the two application cores 10a and 10b and illustrates only the communication processing module 11 and the application module 14, and illustration of modules other than these is omitted.

The two application cores 10a and 10b of the on-board communication apparatus 3 according to Modified Example 2 are respectively provided with the application modules 14 that perform different types of processing by executing application programs for performing different types of processing. The two application cores 10a and 10b have the same hardware configuration (may have different hardware configurations). Due to the on-board communication apparatus 3 including the two application cores 10a and 10b, a plurality of application programs can be executed in parallel.

Note that the three cores of the on-board communication apparatus 3 according to Modified Example 2 may be mounted as individual ICs, for example, and two or three cores may be mounted as a single IC, for example. In addition, the on-board communication apparatus 3 may include three or more application cores. Furthermore, the on-board communication apparatus 3 may include a plurality of application cores and a plurality of real-time cores, and, in this case, for example, an apparatus, a core, or the like that performs processing for relaying communication between a plurality of cores may be provided.

### Modified Example 3

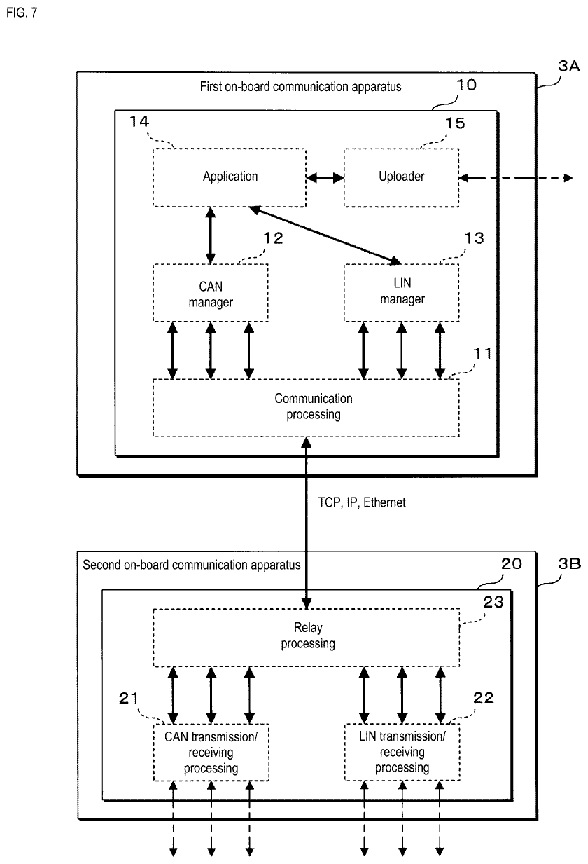

FIG. 7 is a block diagram showing a configuration of an on-board communication system according to Modified Example 3. The on-board communication system according to Modified Example 3 includes a first on-board communication apparatus 3A that includes the application core 10, and a second on-board communication apparatus 3B that includes the real-time core 20. The first on-board communication apparatus 3A and the second on-board communication apparatus 3B are connected to each other via a communication line. The communication processing module 11 of the application core 10 of the first on-board communication apparatus 3A and the relay processing module 23 of the real-time core 20 of the second on-board communication apparatus 3B can perform communication via this communication line based on a communication protocol such as TCP, IP, and Ethernet.

As illustrated in Modified Example 3, the application core 10 and the real-time core 20 may be mounted in a plurality of on-board communication apparatuses in a distributed manner in place of being mounted in one on-board communication apparatus.

### Overview

The on-board communication apparatus 3 according to the present embodiment that has the above configuration includes the application core (application processing unit) 10 and the real-time core (relay processing unit) 20. The application core 10 is a processor, an IC, or the like that executes an application program. The real-time core 20 is a processor, an IC, or the like that relays transmission/reception of data between the application core 10 and at least one ECU (on-board apparatuses) 4 by communicating with the ECU 4, and communicating with the application core 10 using a predetermined communication protocol. The application core 10 includes a plurality of modules that perform processing related to execution of the application program. These modules perform communication using the same predetermined communication protocol as a communication protocol that is used for communication between the application core 10 and the real-time core 20. It can be expected that using the same communication protocol for communication within the application core 10 and external communication in this manner makes it easy to, for example, add a function to the application core 10 or change a function of the application core 10, and the extensibility of the on-board communication apparatus 3 improves.

In addition, in the on-board communication apparatus 3 according to the present embodiment, communication between the application core 10 and the real-time core 20 and communication between a plurality of modules within the application core 10 are performed using the TCP or UDP communication protocol. TCP and UDP are communication protocols that have been conventionally used in a widespread manner, and are expected to realize reliable communication. In addition, TCP and UDP are communication protocols of the transport layer of the OSI reference model, are higher-level protocols than IP that is a communication protocol of the network layer, and can coexist with each other.

In addition, in the on-board communication apparatus 3 according to the present embodiment, the real-time core 20 transmits data received using the LIN communication protocol to the application core 10 using the UDP communication protocol, and transmits data received using the CAN communication protocol to the application core 10 using the TCP communication protocol. Accordingly, in the on-board communication apparatus 3, data that is transmitted/received using the CAN communication protocol that is highly likely to be used to handle data for which relatively high reliability is demanded can be handled using TCP that is a reliable communication protocol, and data that is transmitted/received using the LIN communication protocol that is highly likely to be used to handle data for which relatively high reliability is not demanded can be handled using UDP that is a communication protocol that enables high-speed communication with less reliability.

In addition, for communication between the application core 10 and the real-time core 20 and communication between modules in the application core 10, the on-board communication apparatus 3 according to the present embodiment uses either the TCP or UDP communication protocol in accordance with ASIL demanded for data that is transmitted/received. Accordingly, the on-board communication apparatus 3 can transmit/receive data for which a high safety level is demanded, using the reliable TCP communication protocol, and transmit/receive data for which a low safety level is demanded using the UDP communication protocol that enables higher speed communication with less reliability compared with TCP.

In addition, the on-board communication apparatus 3 according to the present embodiment encrypts data that is transmitted/received between the application core 10 and the real-time core 20, and does not encrypt data that is transmitted/received between a plurality of modules in the application core 10. Accordingly, the on-board communication apparatus 3 can be expected to improve the safety by encrypting data that is easily intercepted from outside, and to transmit/receive data that is not easily intercepted from outside, at a high speed without encrypting it.

Note that, in the present embodiment, communication between cores, namely the application core 10 and the real-time core 20 and communication within a core are performed using the TCP or UDP communication protocol, but there is no limitation thereto, and communication between cores and communication within a core may be performed using various communication protocols other than TCP and UDP, such as DCCP (Datagram Congestion Control Protocol), SCTP (Stream Control Transmission Protocol), RSVP (Resource Reservation Protocol), CAN, and LIN. In addition, in the present embodiment, a configuration is adopted in which the on-board communication apparatus 3 performs communication with the ECUs 4 in the vehicle 1 using the CAN or LIN communication protocol, but there is no limitation thereto, and various communication protocols other than CAN and LIN, such as CAN-FD (CAN with Flexible Data Rate), FlexRay (registered trademark), and Ethernet may be used. In addition, in the present embodiment, an example has been described in which processing for transmitting data to the server apparatus 2 outside the vehicle 1 is performed as an application program that is executed by the application core 10, but there is no limitation thereto, and the application program may be an application program for performing any processing.

The embodiment disclosed herein is exemplary in all respects and should not be interpreted as limiting in any manner. The scope of the present disclosure is defined not by the foregoing meanings, but is defined by the claims, and is intended to include all modifications that are within the meanings and the scope that are equivalent to those of the claims.

### Supplementary Note 1

An on-board communication apparatus to be mounted in a vehicle, including: an application processing unit configured to execute an application program, the application processing unit includes a plurality of modules that perform processing related to execution of the application program, and perform external communication using a predetermined communication protocol, the plurality of modules perform communication using the predetermined communication protocol.

### Supplementary Note 2

A communication method that is performed by an on-board communication apparatus that is to be amounted in a vehicle, and includes: an application processing unit configured to execute an application program, and a relay processing unit configured to relay transmission/reception of data between at least one on-board apparatus and the application processing unit, the application processing unit including a plurality of modules that perform processing related to execution of the application program, and the method includes: performing communication between the application processing unit and the relay processing unit using a predetermined communication protocol, and performing communication between the plurality of modules using the predetermined communication protocol.

### Supplementary Note 3

A computer program for causing a computer to be mounted in a vehicle to operate as: an application processing unit configured to execute an application program, and a relay processing unit configured to communicate with at least one on-board apparatus, communicate with the application processing unit using a predetermined communication protocol, and relay transmission/reception of data between an on-board apparatus and the application processing unit, the application processing unit includes a plurality of modules that perform processing related to execution of the application program, and the plurality of modules perform communication using the predetermined communication protocol.

1. An on-board communication apparatus to be mounted in a vehicle, comprising:
an application processing unit configured to execute an application program; and
a relay processing unit configured to communicate with at least one on-board apparatus, communicate with the application processing unit using a predetermined communication protocol, and relay transmission/reception of data between the on-board apparatus and the application processing unit,
wherein the application processing unit includes a plurality of modules that perform processing related to execution of the application program,
the plurality of modules perform communication using the predetermined communication protocol,
the predetermined communication protocol is TCP (Transmission Control Protocol) or UDP (User Datagram Protocol), and
the application processing unit, the relay processing unit, and the modules transmit/receive data using the TCP or UDP communication protocol in accordance with ASIL (Automotive Safety Integrity Level) demanded for the data.

2. (canceled)

3. The on-board communication apparatus according to claim 1,
wherein the predetermined communication protocol is TCP and UDP,
the relay processing unit;
communicates with the on-board apparatus using LIN (Local Interconnect Network) and CAN (Controller Area Network) communication protocols,
transmits data received using the LIN communication protocol to the application processing unit using the UDP communication protocol, and
transmits data received using the CAN communication protocol to the application processing unit using the TCP communication protocol.

4. (canceled)

5. (canceled)

6. The on-board communication apparatus according to claim 1,
wherein the data that is transmitted/received includes data related to handshake between a plurality of on-board apparatuses or data related to sequence control between a plurality of on-board apparatuses, and
the application processing unit, the relay processing unit, and the modules transmit/receive the data related to handshake or the data related to sequence control using the TCP communication protocol.

7. The on-board communication apparatus according to claim 1,
wherein the data that is transmitted/received includes data related to message authentication or data related to a history of cyberattacks, and
the application processing unit, the relay processing unit, and the modules transmit/receive the data related to message authentication or the data related to a history of cyberattacks using the TCP communication protocol.

8. The on-board communication apparatus according to claim 1,
wherein he data that is transmitted/received includes data related to an indoor condition of the vehicle, and
the application processing unit, the relay processing unit, and the modules transmit/receive the data related to the indoor condition using the UDP communication protocol.

9. The on-board communication apparatus according to claim 1,
the data that is transmitted/received includes time-series data related to a travelling state of the vehicle, and
the application processing unit, the relay processing unit, and the modules transmit/receive the time-series data related to the travelling state using the UDP communication protocol.

10. The on-board communication apparatus according to claim 1,
wherein the data that is transmitted/received between the application processing unit and the relay processing unit is encrypted.

11. An on-board communication apparatus that is to be mounted in a vehicle, comprising
an application core that executes an application program,
wherein the application core executes a plurality of software modules related to the application program, and
the plurality of software modules transmit/receive data using a TCP or UDP communication protocol in accordance with ASIL demanded for the data.

12. An on-board communication system to be mounted in a vehicle, comprising:
an application processing apparatus that executes an application program; and
a relay processing apparatus that communicates with at least one on-board apparatus, communicates with the application processing apparatus using a predetermined communication protocol, and relays transmission/reception of data between the application processing apparatus and the on-board apparatus,
wherein the application processing apparatus includes a plurality of modules that perform processing related to execution of the application program, and
the plurality of modules perform communication using the predetermined communication protocol,
the predetermined communication protocol is TCP or UDP, and
the application processing unit, the relay processing unit, and the modules transmit/receive data using the TCP or UDP communication protocol in accordance with ASIL demanded for the data.
